(19) United States
(12) Patent Application Publication
(10) Pub. No.: US 2025/0350887 A1
(43) Pub. Date: Nov. 13, 2025

(54) VOICE COIL DRIVING SYSTEM AND METHOD OF DRIVING VOICE COIL

(71) Applicant: Tymphany HK Limited, Wanchai (HK)

(72) Inventors: George Albert Bullimore, Taipei City (TW); Ruben Minoru Tuemp Millyard, Taipei City (TW)

(21) Appl. No.: 19/206,846

(22) Filed: May 13, 2025

Related U.S. Application Data
(60) Provisional application No. 63/646,099, filed on May 13, 2024.

(51) Int. Cl. H04R 9/02

(52) U.S. Cl. CPC H04R 9/025; H04R 2209/041

(57) ABSTRACT

A voice coil driving system includes a magnetic circuit, a voice coil and a driving circuit, and the voice coil is suspended in the air gap and includes a plurality of voice coil sections. A method of driving a voice coil performed by the driving circuit comprises: receiving an audio signal; determining whether the audio signal belongs to a first class signal or a second class signal; when determining that the audio signal belongs to the first class signal, selecting a target voice coil section from the voice coil sections according to the excursion of the voice coil and generating and transmitting a first driving signal to the target voice coil section according to the first class signal; when determining that the audio signal belongs to the second class signal, generating and transmitting second driving signals to the voice coil sections according to the second class signal.

### CROSS REFERENCE TO RELATED APPLICATIONS

This application claims priority of U.S. Provisional Application No. 63/646,099 filed on May 13, 2024 under 35 U.S.C. § 119 (e), the entire contents of all of which are hereby incorporated by reference.

### TECHNICAL FIELD OF THE INVENTION

The present disclosure is related to the technical field of speakers and is particularly related to a voice coil driving system and a method of driving a voice coil.

### DESCRIPTION OF THE PRIOR ART

A current voice coil driving system includes a voice coil with a plurality of coil windings. A plurality of driving signals are respectively transmitted to the coil windings to drive the voice coil so that the voice coil moves back and forth to cause vibrations in a diaphragm to generate a sound.

However, the coil windings are not completely disposed in an air gap; specifically, when the voice coil moves back and forth to cause the vibration in the diaphragm, some coil windings are located in the air gap, and other coil windings are not located in the air gap. The coil windings which are not located in the air gap still receive the driving signals and results in heating the voice coil.

In addition, the frequencies of the driving signals are different from one another, the frequency of each driving signal may be a low frequency (e.g., 40 Hz˜160 Hz), a medium frequency signal (e.g., 160 Hz˜2630 Hz) or a high frequency (e.g., 2630 Hz˜5270 Hz), and the excursion of the voice coil corresponding to the low frequency, the excursion of the voice coil corresponding to the medium frequency and the excursion of the voice coil corresponding to the high frequency are different from one another. In the current voice coil driving system, the low frequency driving signal, the medium frequency driving signal and the high frequency driving signal are respectively transmitted to the corresponding different drivers (e.g., a dynamic driver and a balance armature driver), but the different drivers would interfere with one another, thus declining the quality of the sound.

### SUMMARY

In light of the aforementioned descriptions, the present disclosure provides a voice coil driving system and a method of driving a voice coil to improve the problem of heating the voice coil and declining the quality of the sound.

Based on the aforementioned descriptions, the present disclosure provides the voice coil driving system including a magnetic circuit, a voice coil and a driving circuit. The magnetic circuit is provided with an air gap. The voice coil is suspended in the air gap and includes a plurality of voice coil sections. The driving circuit is electrically connected to the voice coil, receives an audio signal, and determines whether the audio signal belongs to a first class signal or a second class signal. When determining that the audio signal belongs to the first class signal, the driving circuit selects a target voice coil section from the voice coil sections according to the excursion of the voice coil and generates and transmits a first driving signal to the target voice coil section according to the first class signal. When determining that the audio signal belongs to the second class signal, the driving circuit generates and transmits second driving signals to the voice coil sections according to the second class signal.

Based on the aforementioned descriptions, the present disclosure provides the method of driving the voice coil for the voice coil driving system. The voice coil driving system includes the magnetic circuit, the voice coil and the driving circuit; the voice coil is suspended in the air gap and includes a plurality of voice coil sections. The method of driving the voice coil performed by the driving circuit comprises: receiving an audio signal; determining whether the audio signal belongs to a first class signal or a second class signal; when determining that the audio signal belongs to the first class signal, selecting a target voice coil section from the voice coil sections according to the excursion of the voice coil and generating and transmitting a first driving signal to the target voice coil section according to the first class signal; when determining that the audio signal belongs to the second class signal, generating and transmitting second driving signals to the voice coil sections according to the second class signal.

In view of the above descriptions, the voice coil driving system and the method of driving the voice coil selectively drives one or more voice coil sections to reduce audio distortion and the energy loss of the voice coil, thereby improving the quality of the sound and the driving efficiency of the voice coil.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1A depicts the schematic diagram of a voice coil driving system according to one embodiment of the present disclosure.

FIG. 1B depicts the configuration diagram of a voice coil according to one embodiment of the present disclosure.

FIG. 1C depicts the block diagram of a driving circuit and a plurality of voice coil sections according to one embodiment of the present disclosure.

FIG. 2 depicts the configuration diagram of a voice coil according to another embodiment of the present disclosure.

FIG. 3 depicts the configuration diagram of a voice coil according to yet embodiment of the present disclosure.

FIG. 4A to FIG. 4C depict the schematic diagram of the back and forth movements of the voice coil according to one embodiment of the present disclosure.

FIG. 5A depicts the configuration diagram of the driving circuit according to one embodiment of the present disclosure.

FIG. 5B depicts the configuration diagram of a DSP according to one embodiment of the present disclosure.

FIG. 6 depicts the configuration diagram of a driving circuit according to another embodiment of the present disclosure.

FIG. 7 depicts the configuration diagram of a driving circuit according to yet embodiment of the present disclosure.

FIG. 8 depicts the flowchart of a method of driving a voice coil according to one embodiment of the present disclosure.

FIG. 9 depicts the flowchart of a method of driving a voice coil according to another embodiment of the present disclosure.

FIG. 10A to FIG. 10C depict the schematic diagram of the back and forth movements of the voice coil according to another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the aforementioned accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

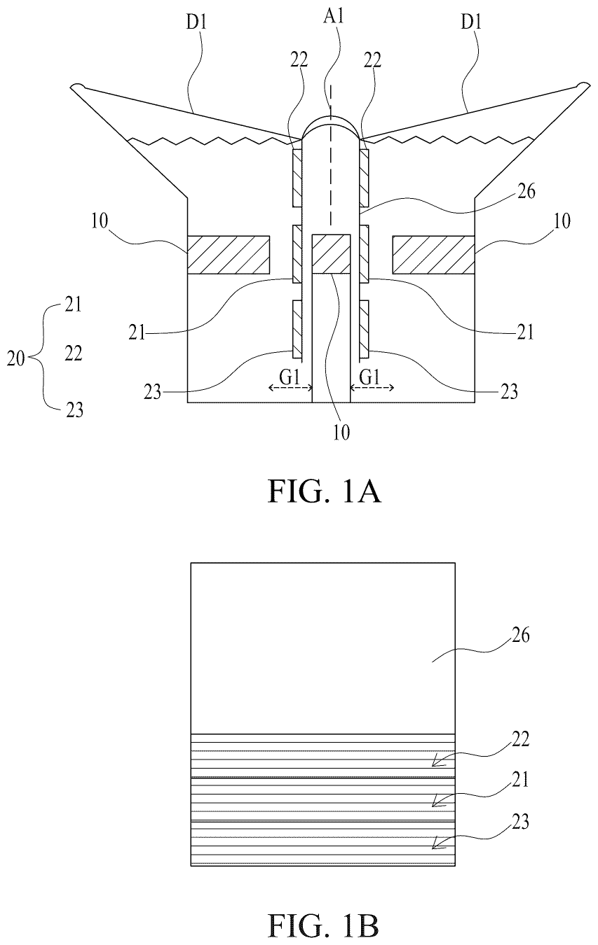

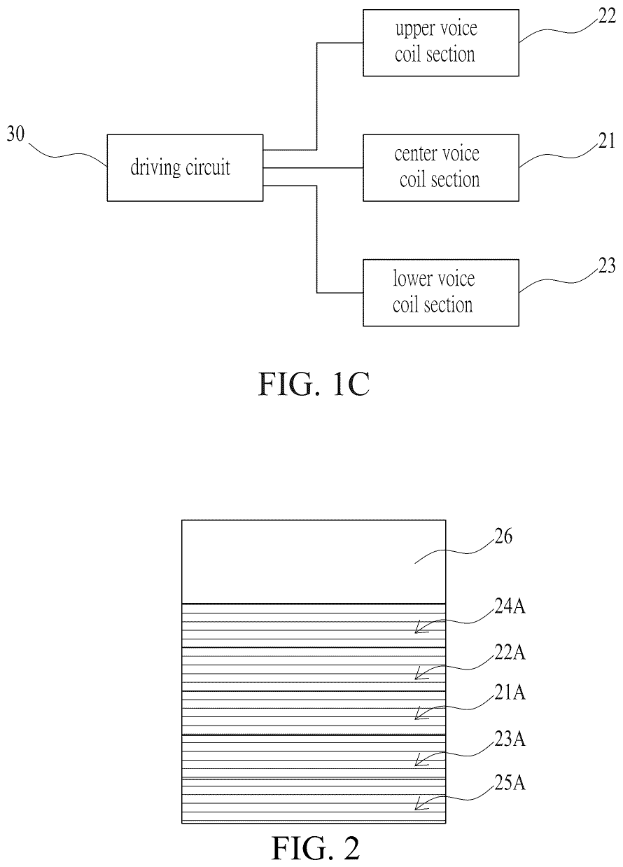

Please refer to FIG. 1A to FIG. 1C, which depict the schematic diagram of a voice coil driving system according to one embodiment of the present disclosure, the configuration diagram of a voice coil according to one embodiment of the present disclosure, and the block diagram of a driving circuit and a plurality of voice coil sections according to one embodiment of the present disclosure. As shown in FIG. 1A to FIG. 1C, a voice coil driving system includes a magnetic circuit 10, a voice coil 20, a driving circuit 30 and a diaphragm D1. The diaphragm D1 is fixed to the voice coil 20.

The magnetic circuit 10 consists of a plurality of magnetic components, and each magnetic component, for example, may be a permanent magnet or magnetic metal. For example, the magnetic circuit 10 consists of two magnetic components, and there is an annular air gap G1 between two magnetic components. The air gap G1, composed of air and is located within the magnetic circuit 10, is the interval between two magnetic components, and may allow the other component, such as the voice coil 20, to be inserted therein.

The voice coil 20 is suspended in the air gap G1 and includes a bobbin 26 and a plurality of voice coil sections coiled on the bobbin 26, and each voice coil section includes a plurality of coil windings. For example, the number of the voice coil sections is three, three voice coil sections are a center voice coil section 21, an upper voice coil section 22 and a lower voice coil section 23, and the upper voice coil section 22 and the lower voice coil section 23 are located on two sides of the center voice coil section 21. The center voice coil section 21, the upper voice coil section 22 and the lower voice coil section 23 are all coiled on the bobbin 26 based on a travelling axis A1 and separately shift along the travelling axis A1 by electromotive force (EMF), thereby causing the voice coil 20 to move back and forth along the travelling axis A1. The back and forth movements of the voice coil 20 along the travelling axis A1 drives the diaphragm D1 to vibrate in order to generate a sound.

It should be noted that the magnetic component is encircled by the voice coil 20 so that one part of the voice coil 20 is located in the air gap G1 and the other part of the voice coil 20 is not located in the air gap G1. Correspondingly, taking the configuration of the voice coil 20 shown in FIG. 1A and FIG. 1B as an example, the center voice coil section 21 is located in the air gap G1, and the upper voice coil section 22 and the lower voice coil section 23 are not located in the air gap G1. Because the voice coil 20 moves back and forth along the travelling axis A1, the voice coil section which is located in the air gap G1 is not fixed and is changed as the voice coil 20 moves back and forth. In other words, the voice coil section which is located in the air gap G1 may be one of the center voice coil section 21, the upper voice coil section 22 and the lower voice coil section 23.

The driving circuit 30 is electrically connected to the voice coil 20. Specifically, the driving circuit 30 is electrically connected to the center voice coil section 21, the upper voice coil section 22 and the lower voice coil section 23 and receives an audio signal by an input terminal. The center voice coil section 21, the upper voice coil section 22 and the lower voice coil section 23 separately generate EMF due to driving signals. The value of the EMF is associated with a magnetic field; furthermore, the influence of the magnetic field on the voice coil section which is located in the air gap G1 is greater than the influence of the magnetic field on the voice coil section which is not located in the air gap G1, and the EMF generated by the voice coil section which is located in the air gap G1 is greater than the EMF generated by the voice coil section which is not located in the air gap G1. Taking the configuration of the voice coil 20 shown in FIG. 1A and FIG. 1B as an example, the EMF generated by the center voice coil section 21 is greater than the EMF generated by the upper voice coil section 22 and the EMF generated by the lower voice coil section 23.

Because the amount of EMF corresponding to the voice coil sections is different, and the excursion of the voice coil 20 when receiving a low frequency driving signal is greater than the excursion of the voice coil 20 when receiving a high frequency driving signal, it should be avoided that the low frequency driving signal is transmitted to the voice coil section which is not located in the air gap G1. It should be explained that the excursion of the voice coil 20 is the distance between the position of the voice coil 20 when being static and the position of the voice coil 20 when moving.

The driving circuit 30 receives the audio signal. Specifically, the frequency of the audio signal may be a low frequency, a medium frequency or a high frequency, and the operation of the driving circuit 30 would be different due to the low frequency audio signal, the medium frequency audio signal and the high frequency audio signal; the driving circuit 30 classifies the low frequency audio signal into a first class signal and classifies the medium frequency audio signal and the high frequency into a second class signal. When receiving the first class signal, the driving circuit 30 selectively generates and transmits a first driving signal to one of the center voice coil section 21, the upper voice coil section 22 and the lower voice coil section 23. When receiving the second class signal, the driving circuit 30 generates and transmits second driving signals to the center voice coil section 21, the upper voice coil section 22 and the lower voice coil section 23.

Please refer to FIG. 2, which depicts the configuration diagram of a voice coil according to another embodiment of the present disclosure. As shown in FIG. 2, the voice coil 20 includes five voice coil sections, and five voice coil sections are the center voice coil section 21A, a first upper voice coil section 22A, a first lower voice coil section 23A, a second upper voice coil section 24A and a second lower voice coil section 25A. The center voice coil section 21A, the first upper voice coil section 22A, the first lower voice coil section 23A, the second upper voice coil section 24A and the second lower voice coil section 25A are all electrically connected to the driving circuit 30 shown in FIG. 1C to separately receive the driving signals. The first upper voice coil section 22A and the first lower voice coil section 23A are located on two opposite sides of the center voice coil section 21A, the second upper voice coil section 24A is located above the first upper voice coil section 22A, and the second lower voice coil section 25A is located below the first lower voice coil section 23A. In other words, the first upper voice coil section 22A is located between the second upper voice coil section 24A and the center voice coil section 21A, and the first lower voice coil section 23A is located between the second lower voice coil section 25A and the center voice coil section 21A.

In conjunction with FIG. 1A, the center voice coil section 21A is located in the air gap G1, and the first upper voice coil section 22A, the first lower voice coil section 23A, the second upper voice coil section 24A and the second lower voice coil section 25A are not located in the air gap G1. Similarly, because the voice coil 20 moves back and forth along the travelling axis A1, the voice coil section which is located in the air gap G1 may be one of the center voice coil section 21A, the first upper voice coil section 22A, the first lower voice coil section 23A, the second upper voice coil section 24A and the second lower voice coil section 25A.

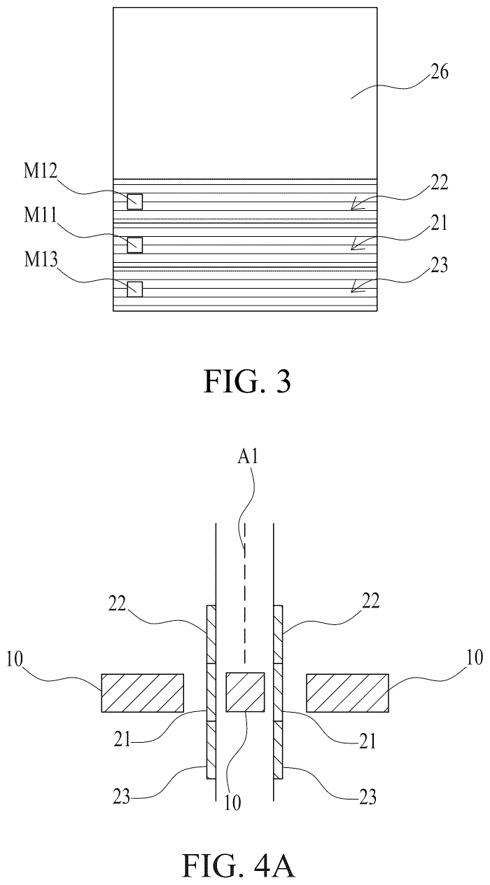

Please refer to FIG. 3, which depicts the configuration diagram of a voice coil according to yet embodiment of the present disclosure. As shown in FIG. 3, the voice coil 20 similar to voice coil 20 shown in FIG. 2 includes the center voice coil section 21, the upper voice coil section 22 and the lower voice coil section 23, and the detailed configurations of the center voice coil section 21, the upper voice coil section 22 and the lower voice coil section 23 would not be repeated. However, there is the difference between FIG. 2 and FIG. 3 as follows: a plurality of excursion measurement units M11˜M13 are respectively disposed on the center voice coil section 21, the upper voice coil section 22 and the lower voice coil section 23. Specifically, the excursion measurement unit M11 is disposed on the center voice coil section 21 to measure the displacement of the center voice coil section 21; the excursion measurement unit M12 is disposed on the upper voice coil section 22 to measure the displacement of the upper voice coil section 22; the excursion measurement unit M13 is disposed on the lower voice coil section 23 to measure the displacement of the lower voice coil section 23. In conjunction with FIG. 1C, the driving circuit 30 is electrically connected to the excursion measurement units M11˜M13 to obtain the displacement of the center voice coil section 21, the displacement of the upper voice coil section 22 and the displacement of the lower voice coil section 23 and calculates the excursion of the voice coil 20 according to the displacement of the center voice coil section 21, the displacement of the upper voice coil section 22 and the displacement of the lower voice coil section 23.

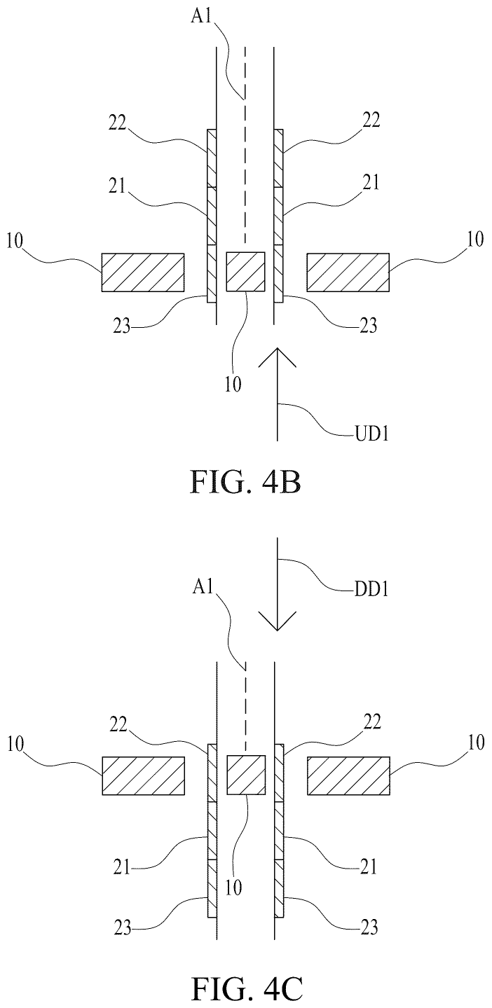

The following would explain the back and forth movements of the voice coil 20 in conjunction with FIG. 4A to FIG. 4C.

As shown in FIG. 4A, the voice coil 20 does not receive any driving signal and is situated at a static position, the center voice coil section 21 is located in the air gap G1, and the upper voice coil section 22 and the lower voice coil section 23 are not located in the air gap G1.

As shown in FIG. 4B, when the driving circuit 30 transmits a positive driving signal to the voice coil 20, the surroundings of the voice coil 20 generate a first induced magnetic field and first EMF due to the positive driving signal. In conjunction with FIG. 1A, under the collaborative effects of the first induced magnetic field generated by the voice coil 20 and the magnetic field provided by the magnetic circuit 10, the voice coil 20 moves in an upward direction UD1 to push the diaphragm D1. At present, the lower voice coil section 23 is located in the air gap G1, and the center voice coil section 21 and the upper voice coil section 22 are not located in the air gap G1.

As shown in FIG. 4C, after the voice coil 20 pushes the diaphragm D1, the driving circuit 30 transmits a negative driving signal to the voice coil 20, and the surroundings of the voice coil 20 generate a second induced magnetic field and second EMF due to the negative driving signal. In conjunction with FIG. 1A, under the collaborative effects of the second induced magnetic field generated by the voice coil 20 and the magnetic field provided by the magnetic circuit 10, the voice coil 20 moves in a downward direction DD1. At present, the upper voice coil section 22 is located in the air gap G1, and the center voice coil section 21 and the lower voice coil section 23 are not located in the air gap G1.

According to the explanation corresponding to FIG. 4A to FIG. 4C, the diaphragm D1 is driven to vibrate in order to cause the surrounding air to vibrate by the back and forth movements of the voice coil 20, thereby generating the sound.

The following would elaborate the detailed configurations of the various driving circuits 30.

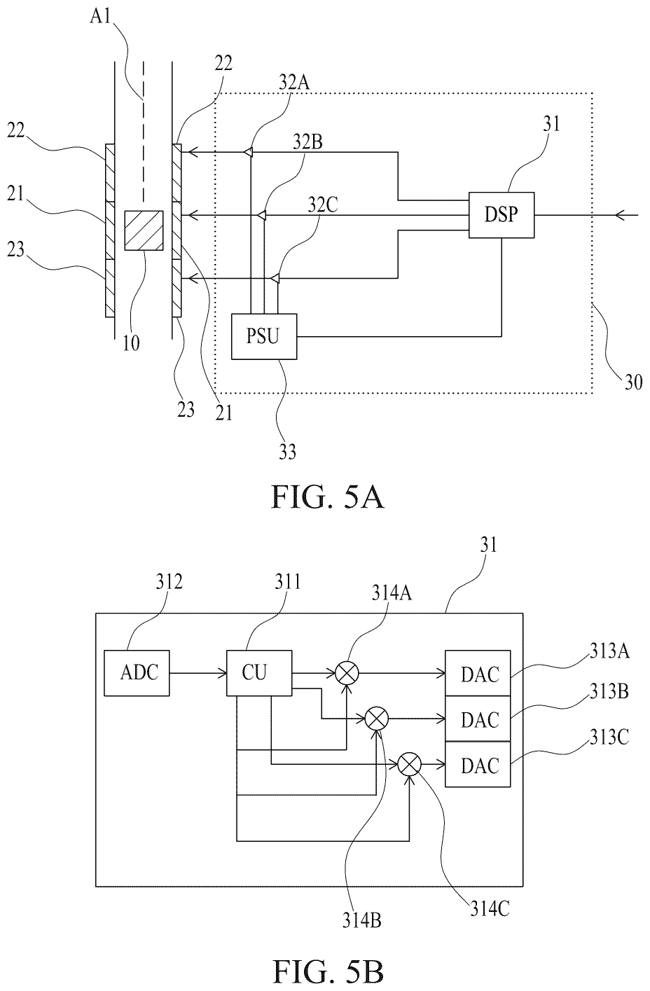

Please refer to FIG. 5A, which depicts the configuration diagram of the driving circuit according to one embodiment of the present disclosure. As shown in FIG. 5A, the driving circuit 30 includes a DSP (DSP) 31, a PSU (PSU) 33 and a plurality of amplifiers 32A, 32B and 32C.

The DSP 31 is electrically connected to the amplifiers 32A, 32B and 32C, and the PSU 33, generates the first driving signal according to the first class signal, and generates the second driving signals according to the second class signal. When receiving the first class signal, the DSP 31 generates and transmits a control signal to the PSU 33.

The PSU 33 is electrically connected to the amplifiers 32A, 32B and 32C, controls the activation of the amplifiers 32A, 32B and 32C, and provides the DSP 31 and the amplifiers 32A, 32B and 32C with power. The amplifiers 32A, 32B and 32C are electrically connected to the upper voice coil section 22, the center voice coil section 21 and the lower voice coil section 23. Although the number of the amplifiers shown in FIG. 5A is three, the number of the amplifiers may be adjusted according to the number of the voice coil sections and not be limited to three. Taking the voice coil 20 shown in FIG. 2 as an example, the voice coil 20 includes five voice coil sections, and the number of the amplifiers is correspondingly adjusted to five.

When transmitting the first driving signal to one of the amplifiers 32A, 32B and 32C, the DSP 31 generates and transmits the control signal to the PSU 33, the PSU 33 activates the amplifier receiving the first driving signal according to the control signal, and the amplifier receiving the first driving signal (e.g., the amplifier 32B) amplifies and transmits the first driving signal to the corresponding voice coil section disposed in the air gap G1 (e.g., the center voice coil section 21).

When transmitting the second driving signals to the amplifiers 32A, 32B and 32C, the DSP 31 generates and transmits the control signal to the PSU 33, the PSU 33 activates the amplifiers 32A, 32B and 32C according to the control signal, and the amplifiers 32A, 32B and 32C respectively amplify and transmit the second driving signals to the upper voice coil section 22, the center voice coil section 21 and the lower voice coil section 23.

Please refer to FIG. 5B, which depicts the configuration diagram of a DSP according to one embodiment of the present disclosure. As shown in FIG. 5B, the DSP 31 includes a compute unit (CU) 311, an analog-to-digital converter (ADC) 312, audio mixers 314A, 314B and 314C and digital-to-analog converters (DACs) 313A, 313B and 313C.

The ADC 312 converts the first class signal belonging to an analog signal into the first class signal belonging to a digital signal and converts the second class signal belonging to the analog signal into the second class signals belonging to the digital signal. The CU 311 receives the first class signal belonging to the digital signal and the second class signals belonging to the digital signal from the ADC 312, transmits the first class signal belonging to the digital signal to one of the audio mixers 314A, 314B and 314C, and transmits the second class signals belonging to the digital signal to the audio mixers 314A, 314B and 314C. In one embodiment, the second class signals belonging to the digital signal are synchronously transmitted to the audio mixers 314A, 314B and 314C.

In collaboration with FIG. 5A and FIG. 1A, when receiving the first class signal belonging to the digital signal, the CU 311 calculates the excursion of the voice coil 20 according to the frequency of the first class signal and a frequency-level-excursion function, determines what the voice coil section located in the air gap G1 is (e.g., the center voice coil section 21) according to the excursion of the voice coil 20, and generates and transmits a base signal to the audio mixer (e.g., the audio mixer 314B) corresponding to the voice coil section located in the air gap G1, and the audio mixer (e.g., the audio mixer 314B) corresponding to the voice coil section located in the air gap G1 combines the base signal and the first class signal belonging to the digital signal into the first driving signal belonging to the digital signal. Afterwards, the DAC (e.g., DAC 313B) corresponding to the voice coil section located in the air gap G1 receives the first driving signal belonging to the digital signal from the audio mixer (e.g., the audio mixer 314B) corresponding to the voice coil section located in the air gap G1, and converts the first driving signal belonging to the digital signal into the first driving signal belonging to the analog signal.

In collaboration with FIG. 5A and FIG. 1A, when receiving the second class signals belonging to the digital signal, the CU transmits three base signals to the audio mixers 314A, 314B and 314C, and the audio mixers 314A, 314B and 314C separately combine the base signals and the second class signals belonging to the digital signal into three second driving signals belonging to the digital signal. Afterwards, the DACs 313A, 313B and 313C receive three second driving signals belonging to the digital signal from the audio mixers 314A, 314B and 314C and convert three second driving signals belonging to the digital signal into three second driving signals belonging to the analog signal.

In addition, in order to prevent the frequency of a baseband signal from influencing the first driving signal belonging to the digital signal and the second driving signals belonging to the digital signal, the CU 311 sets the value of the frequency of the baseband signal to be the same as the value of the frequency of the first driving signal belonging to the digital signal or sets the value of the frequency of the baseband signal to be the same as the value of the frequency of the second driving signal belonging to the digital signal and fixes the value of the baseband signal.

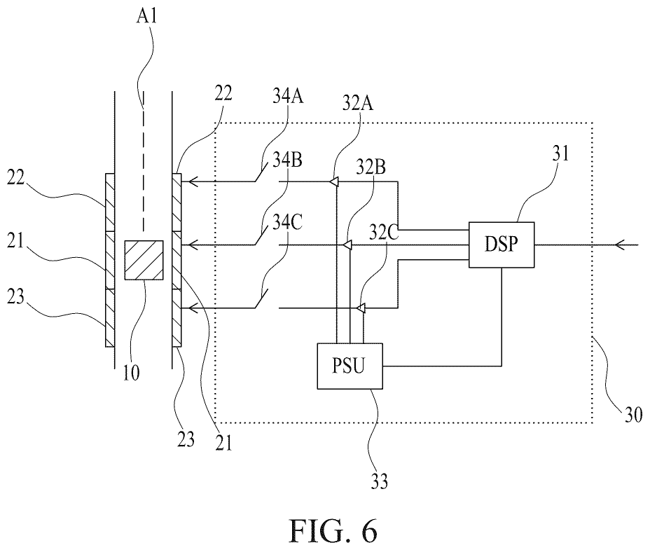

Please refer to FIG. 6, which depicts the configuration diagram of a driving circuit according to another embodiment of the present disclosure. As shown in FIG. 6, the driving circuit 30 includes the DSP 31, the PSU 33, the plurality of amplifiers 32A, 32B and 32C, and a plurality of switches 34A, 34B and 34C; the DSP 31, the PSU 33 and the amplifiers 32A, 32B and 32C shown in FIG. 6 are similar to the DSP 31, the PSU 33 and the amplifiers 32A, 32B and 32C shown in FIG. 5A, and the similarities between FIG. 6 and FIG. 5A would not be repeated.

The switch 34A is electrically connected to the amplifier 32A, the upper voice coil section 22 and the DSP 31, the switch 34B is electrically connected to the amplifier 32B, the center voice coil section 21 and the DSP 31, and the switch 34C is electrically connected to the amplifier 32C, the lower voice coil section 23 and the DSP 31. The DSP 31 controls the conduction of the switches 34A, 34B and 34C.

When the first driving signal is transmitted to one of the amplifiers 32A, 32B and 32C, the amplifier receiving the first driving signal (e.g., the amplifier 32B) amplifies and transmits the first driving signal to the corresponding switch (e.g., the switch 34B). Afterwards, the DSP 31 generates and transmits the control signal to the switch (e.g., the switch 34B) corresponding to the amplifier receiving the first driving signal, the switch (e.g., the switch 34B) corresponding to the amplifier receiving the first driving signal is turned on, and the amplified first driving signal is transmitted to the corresponding voice coil section disposed in the air gap G1 (e.g., the center voice coil section 21).

When the second driving signals are transmitted to the amplifiers 32A, 32B and 32C, the amplifiers 32A, 32B and 32C respectively amplify and transmit the second driving signals to the switches 34A, 34B and 34C. Afterwards, the DSP 31 generates and transmits the control signals to the switches 34A, 34B and 34C, the switches 34A, 34B and 34C are turned on, and three amplified second driving signals are respectively transmitted to the upper voice coil section 22, the center voice coil section 21 and the lower voice coil section 23.

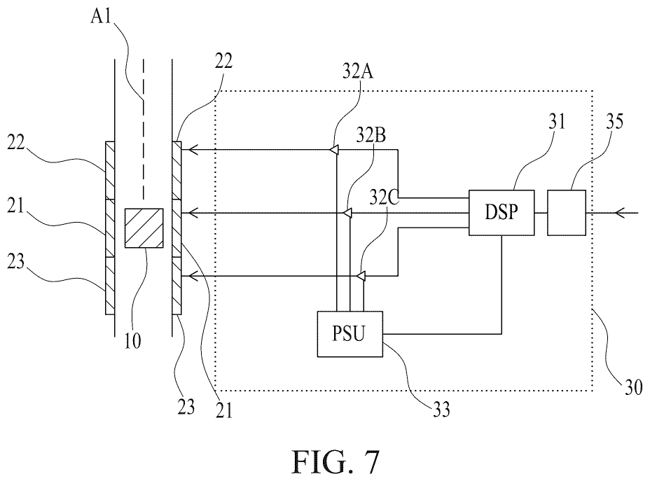

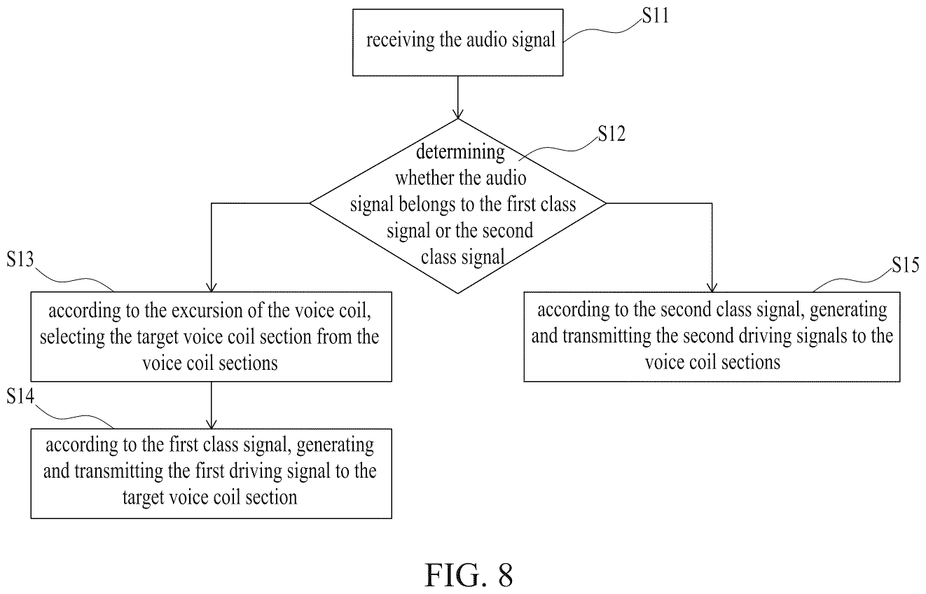

Please refer to FIG. 7, which depicts the configuration diagram of a driving circuit according to yet embodiment of the present disclosure. As shown in FIG. 7, the driving circuit 30 includes the DSP 31, the PSU 33, the plurality of amplifiers 32A, 32B and 32C and a frequency divider 35; the DSP 31, the PSU 33 and the amplifiers 32A, 32B and 32C shown in FIG. 7 are similar to the DSP 31, the PSU 33 and the amplifiers 32A, 32B and 32C shown in FIG. 5A, and the similarities between FIG. 7 and FIG. 5A would not be repeated.

The frequency divider 35 is electrically connected to the DSP 31. Considering that the audio signal may be a hybrid frequency signal including the first class signal and the second class signal, the frequency divider 35 distinguishes the first class signal and the second class signal from the audio signal and transmits the first class signal and the second class signal to the DSP 31.

Please refer to FIG. 8, which depicts the flowchart of a method of driving a voice coil according to one embodiment of the present disclosure. As shown in FIG. 8, a method of driving a voice coil includes step S11 to step S15. The method of driving the voice coil may be applicable to the voice coil driving system shown in FIG. 1A to FIG. 1C, the driving circuit 30 shown in FIG. 5A and the DSP 31 shown in FIG. 5B but not be limited to thereto. Step S11 to step S15 would be explained by the voice coil driving system shown in FIG. 1A to FIG. 1C, the driving circuit 30 shown in FIG. 5A and the DSP 31 shown in FIG. 5B as follows.

Step S11: receiving the audio signal. As described above, the DSP 31 receives the audio signal belonging to the analog signal, and the ADC 312 converts the audio signal belonging to the analog signal into the audio signal belonging to the digital signal.

Step S12: determining whether the audio signal belongs to the first class signal or the second class signal. Specifically, the CU 311 receives the audio signal belonging to the digital signal from the ADC 312 and determines whether the audio signal belonging to the digital signal belongs to the first class signal or the second class signal according to the value of the frequency of the audio signal belonging to the digital signal.

When determining that the audio signal belonging to the digital signal belongs to the first class signal, the DSP 31 subsequently performs step S13. When determining that the audio signal belonging to the digital signal belongs to the second class signal, the DSP 31 subsequently performs step S15.

Step S13: according to the excursion of the voice coil 20, selecting the target voice coil section from the voice coil sections.

In one embodiment, the CU 311 calculates the excursion of the voice coil 20 according to the frequency of the first class signal and the frequency-level-excursion function and selects one of the center voice coil section 21, the upper voice coil section 22 and the lower voice coil section 23 as the target voice coil section according to the excursion of the voice coil 20. For example, as shown in FIG. 4A, the CU 311 calculates the excursion of the voice coil 20 according to the frequency of the first class signal and the frequency-level-excursion function and determines that the voice coil 20 lies on the static state based on the excursion of the voice coil 20, and the voice coil section which is located in the air gap G1 is the center voice coil section 21. Afterwards, the CU 311 selects the center voice coil section 21 as the target voice coil section; correspondingly, the DSP 31 transmits the control signal to the PSU 33, and the PSU 33 activates the amplifier 32B.

In another embodiment, the DSP 31 obtains the displacement of the center voice coil section 21, the displacement of the upper voice coil section 22 and the displacement of the lower voice coil section 23 from the excursion measurement units M11˜M13 shown in FIG. 3 and calculates the excursion of the voice coil 20 according to the displacement of the center voice coil section 21, the displacement of the upper voice coil section 22 and the displacement of the lower voice coil section 23. Afterwards, the DSP 31 selects one of the center voice coil section 21, the upper voice coil section 22 and the lower voice coil section 23 as the target voice coil section according to the excursion of the voice coil 20. For example, as shown in FIG. 4B and FIG. 1A, the DSP 31 determines that the voice coil 20 approaches in a direction toward the diaphragm D1 based on the excursion of the voice coil 20, and the voice coil section which is located in the air gap G1 is the lower voice coil section 23. Afterwards, the CU 311 selects the lower voice coil section 23 as the target voice coil section; correspondingly, the DSP 31 transmits the control signal to the PSU 33, and the PSU 33 activates the amplifier 32C.

Step S14: according to the first class signal, transmitting the first driving signal to the target voice coil section. Specifically, the CU 311 transmits the base signal to the audio mixer 314B, and the audio mixer 314B combines the base signal and the first class signal belonging to the digital signal into the first driving signal belonging to the digital signal; the DAC 313B converts the first driving signal belonging to the digital signal into the first driving signal belonging to the analog signal. Afterwards, the amplifier 32B amplifies and transmits the first driving signal belonging to the analog signal to the center voice coil section 21.

Step S15: according to the second class signal, generating and transmitting the second driving signals to the voice coil sections. Specifically, the CU 311 separately transmits the second class signal to the audio mixers 314A, 314B and 314C, and the audio mixers 314A, 314B and 314C separately combine the base signals and the second class signals belonging to the digital signal into the second driving signals belonging to the digital signal. Afterwards, the DACs 313A, 313B and 313C separately convert three second driving signals belonging to the digital signal into three second driving signals belonging to the analog signal. Finally, the amplifiers 32A, 32B and 32C respectively amplify and transmit the second driving signals belonging to the analog signal simultaneously to the upper voice coil section 22, the center voice coil section 21 and the lower voice coil section 23.

In the method of driving the voice coil of the present embodiment, the target voice coil section or the entire voice coil sections is selectively driven by determining whether the audio signal belongs to the first class signal or the second class signal to reduce audio distortion and the energy loss of the voice coil, thereby improving the quality of the sound and the driving efficiency of the voice coil.

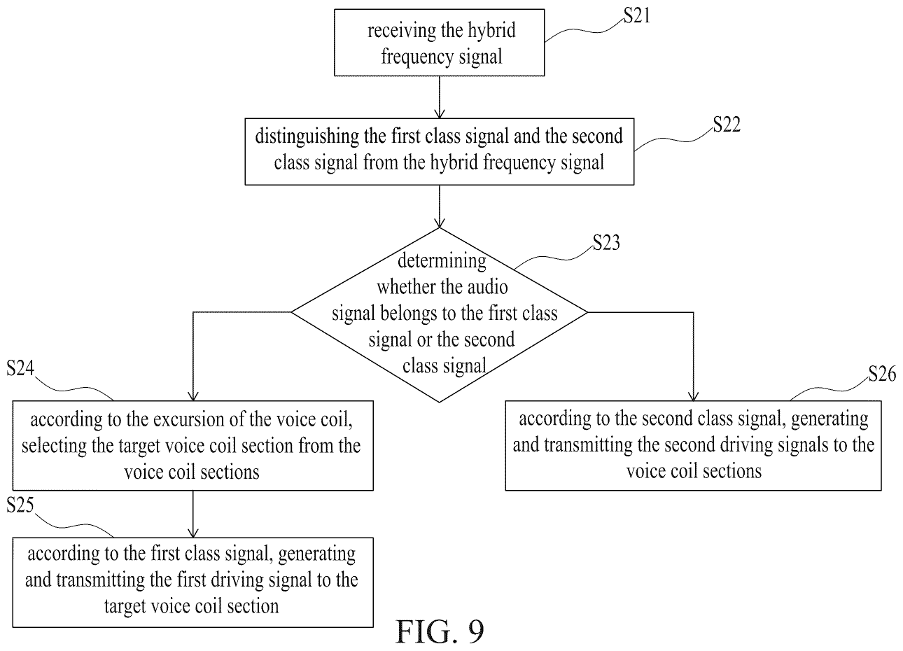

Please refer to FIG. 9, which depicts the flowchart of a method of driving a voice coil according to another embodiment of the present disclosure. As shown in FIG. 9, a method of driving a voice coil includes step S21 to step S26, and step S23 to step S26 are the same as step S12 to step S15 and would not be repeated. The method of driving the voice coil shown in FIG. 9 may be applicable to the voice coil driving system shown in FIG. 1A to FIG. 1C, the driving circuit 30 shown in FIG. 7 and the DSP 31 shown in FIG. 5B but not be limited to thereto. Step S21 and step S22 would be explained by the voice coil driving system shown in FIG. 1A to FIG. 1C, the driving circuit 30 shown in FIG. 7 and the DSP 31 shown in FIG. 5B as follows.

Step S21: receiving the hybrid frequency signal.

Step S22: distinguishing the first class signal and the second class signal from the hybrid frequency signal.

Step S21 and step S22 are all performed by the frequency divider 35, and the frequency divider 35 transmits the first class signal and the second class signal to the CU 311.

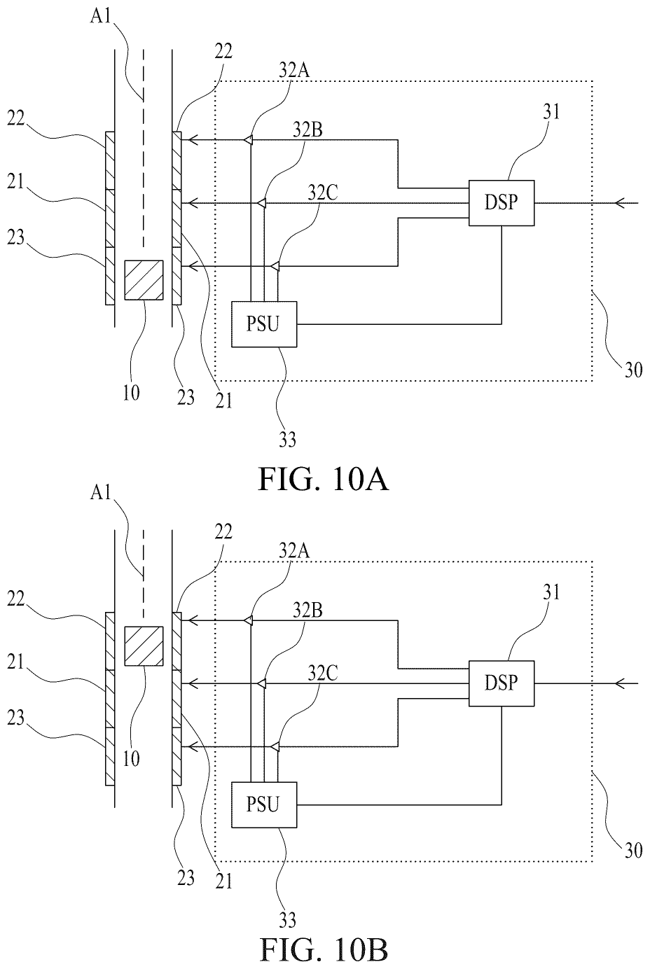

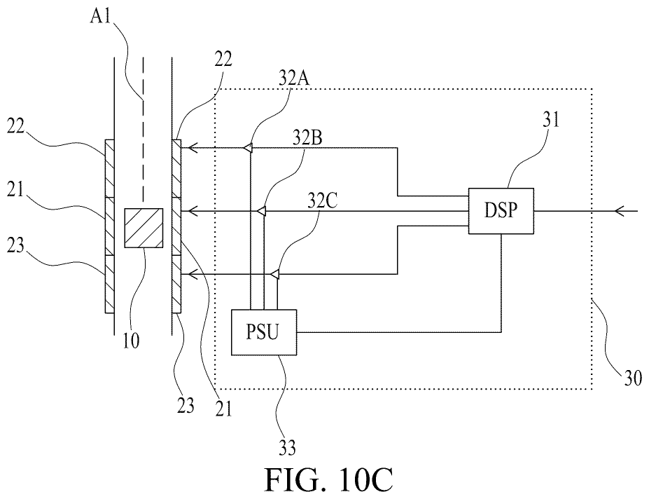

The following would explain the situations of receiving the driving signals by the voice coil 20 when moving back and forth in conjunction with FIG. 10A to FIG. 10C.

As shown in FIG. 10A, the voice coil 20 is situated at the static position, the center voice coil section 21 is located in the air gap G1, and the upper voice coil section 22 and the lower voice coil section 23 are not located in the air gap G1. Please refer to FIG. 7 again. The DSP 31 selects the center voice coil section 21 as the target voice coil section and receives the first class signal and the second class signal from the frequency divider 35; the ADC 312 converts the first class signal and the second class signal belonging to the analog signal into the first class signal and the second class signals belonging to the digital signal. The CU 311 transmits the first class signal belonging to the digital signal to the audio mixer 314B and separately transmits the second class signals belonging to the digital signal to the audio mixers 314A, 314B and 314C.

The audio mixer 314B combines the base signal and the first class signal belonging to the digital signal into the first driving signal belonging to the digital signal, and the DAC 313B converts the first driving signal belonging to the digital signal into the first driving signal belonging to the analog signal. Afterwards, the amplifier 32B amplifies and transmits the first driving signal belonging to the analog signal to the center voice coil section 21.

The audio mixers 314A, 314B and 314C separately combine the base signals and the second class signals belonging to the digital signal into the second driving signals belonging to the digital signal, and the DACs 313A, 313B and 313C separately convert three second driving signals belonging to the digital signal into three second driving signals belonging to the analog signal. Afterwards, the amplifier 32A, 32B and 32C respectively and synchronously amplify and transmit the second driving signals belonging to the analog signal to the upper voice coil section 22, the center voice coil section 21 and the lower voice coil section 23. In other words, the center voice coil section 21 synchronously receives or sequentially receives the first driving signal and the second driving signal, while the upper voice coil section 22 and the lower voice coil section 23 merely receive the second driving signals.

As shown in FIG. 10B, the voice coil 20 moves upward, the lower voice coil section 23 is located in the air gap G1, and the center voice coil section 21 and the upper voice coil section 22 are not located in the air gap G1. Please refer to FIG. 7 again. The DSP 31 selects the lower voice coil section 23 as the target voice coil section and receives the first class signal and the second class signal from the frequency divider 35; the ADC 312 converts the first class signal and the second class signal belonging to the analog signal into the first class signal and the second class signals belonging to the digital signal. The CU 311 transmits the first class signal belonging to the digital signal to the audio mixer 314C and separately transmits the second class signals belonging to the digital signal to the audio mixers 314A, 314B and 314C.

The audio mixer 314C combines the base signal and the first class signal belonging to the digital signal into the first driving signal belonging to the digital signal, and the DAC 313C converts the first driving signal belonging to the digital signal into the first driving signal belonging to the analog signal. Afterwards, the amplifier 32C amplifies and transmits the first driving signal belonging to the analog signal to the lower voice coil section 23.

The audio mixers 314A, 314B and 314C separately combine the base signals and the second class signals belonging to the digital signal into the second driving signals belonging to the digital signal, and the DACs 313A, 313B and 313C separately convert three second driving signals belonging to the digital signal into three second driving signals belonging to the analog signal. Afterwards, the amplifier 32A, 32B and 32C respectively and synchronously amplify and transmit the second driving signals belonging to the analog signal to the upper voice coil section 22, the center voice coil section 21 and the lower voice coil section 23. In other words, the lower voice coil section 23 synchronously receives or sequentially receives the first driving signal and the second driving signal, while the upper voice coil section 22 and the center voice coil section 21 merely receive the second driving signals.

As shown in FIG. 10C, the voice coil 20 moves downward, the upper voice coil section 22 is located in the air gap G1, and the center voice coil section 21 and the lower voice coil section 23 are not located in the air gap G1. Please refer to FIG. 7 again. The DSP 31 selects the upper voice coil section 22 as the target voice coil section and receives the first class signal and the second class signal from the frequency divider 35; the ADC 312 converts the first class signal and the second class signal belonging to the analog signal into the first class signal and the second class signals belonging to the digital signal. The CU 311 transmits the first class signal belonging to the digital signal to the audio mixer 314A and separately transmits the second class signals belonging to the digital signal to the audio mixers 314A, 314B and 314C.

The audio mixer 314A combines the base signal and the first class signal belonging to the digital signal into the first driving signal belonging to the digital signal, and the DAC 313A converts the first driving signal belonging to the digital signal into the first driving signal belonging to the analog signal. Afterwards, the amplifier 32A amplifies and transmits the first driving signal belonging to the analog signal to the upper voice coil section 22.

The audio mixers 314A, 314B and 314C separately combine the base signals and the second class signals belonging to the digital signal into the second driving signals belonging to the digital signal, and the DACs 313A, 313B and 313C separately convert three second driving signals belonging to the digital signal into three second driving signals belonging to the analog signal. Afterwards, the amplifier 32A, 32B and 32C respectively and synchronously amplify and transmit the second driving signals belonging to the analog signal to the upper voice coil section 22, the center voice coil section 21 and the lower voice coil section 23. In other words, the upper voice coil section 22 synchronously receives or sequentially receives the first driving signal and the second driving signal, while the center voice coil section 21 and the lower voice coil section 23 merely receive the second driving signals.

In view of the above descriptions, one of the features of the present disclosure is that the driving circuit continues to classify the audio signal into the first class signal and the second class signal instantly when the audio signal is inputted into the driving circuit of the voice coil driving system, wherein the second class signal would be continuously and synchronously provided for the entire voice coil sections, while the first class signal would be dynamically provided for the voice coil section which is located in the magnetic gap. In other words, the first class signal would be frequently switched to the target voice coil section which is located in the magnetic gap.

In the method of driving the voice coil of the present embodiment, the condition that the audio signal is the hybrid frequency signal is further considered, and the voice coil may be thus driven according to the low frequency audio signal, the medium frequency audio signal and the high frequency audio signal.

In view of the above descriptions, the voice coil driving system and the method of driving the voice coil selectively drives one or more voice coil sections to reduce the audio distortion and the energy loss of the voice coil, thereby improving the quality of the sound and the driving efficiency of the voice coil.

What is claimed is:

1. A voice coil driving system comprising:
a magnetic circuit provided with an air gap;
a voice coil suspended in the air gap and comprising a plurality of voice coil sections; and
a driving circuit electrically connected to the voice coil, receiving an audio signal, and determining whether the audio signal belongs to a first class signal or a second class signal;
wherein the driving circuit selects a target voice coil section from the voice coil sections according to an excursion of the voice coil and generates and transmits a first driving signal to the target voice coil section according to the first class signal when determining that the audio signal belongs to the first class signal;
wherein the driving circuit generates and transmits second driving signals to the voice coil sections according to the second class signal when determining that the audio signal belongs to the second class signal.

2. The voice coil driving system according to claim 1, wherein the first class signal is a low frequency signal, and the second class signal is a medium frequency signal and a high frequency signal.

3. The voice coil driving system according to claim 1, wherein the target voice coil section is located in the air gap.

4. The voice coil driving system according to claim 1, wherein the driving circuit calculates the excursion of the voice coil according to a frequency of the first class signal.

5. The voice coil driving system according to claim 1, further comprising a plurality of excursion measurement units disposed on the voice coil sections and respectively measuring a displacement of the corresponding voice coil section.

6. The voice coil driving system according to claim 1, wherein the driving circuit comprises:
a DSP generating the first driving signal or the second driving signals according to the audio signal;
a plurality of amplifiers electrically connected to the DSP and the voice coil sections; and
a PSU electrically connected to the amplifiers and the DSP and receiving a control signal from the DSP;
wherein the PSU activates the amplifier corresponding to the target voice coil section when the driving circuit determines that the audio signal belongs to the first class signal, and the amplifier corresponding to the target voice coil section amplifies and transmits the first driving signal to the target voice coil section;
wherein the PSU activates the amplifiers when the driving circuit determines that the audio signal belongs to the second class signal, and the amplifiers respectively amplify and transmit the second driving signals to the voice coil sections.

7. The voice coil driving system according to claim 1, wherein the driving circuit comprises:
a DSP generating the first driving signal or the second driving signals according to the audio signal;
a plurality of amplifiers electrically connected to the DSP and amplifying the first driving signal or the second driving signals;
a PSU electrically connected to the amplifiers and the DSP to provide the DSP and the amplifiers with power;
a plurality of switches each of which is electrically connected to the one amplifier, the one voice coil section, and the DSP;
wherein the DSP transmits a control signal to the switch corresponding to the target voice coil section when the driving circuit determines that the audio signal belongs to the first class signal, the switch corresponding to the target voice coil section is turned on, and the first driving signal after the switch corresponding to the target voice coil section is turned on is transmitted to the target voice coil section;
wherein the DSP transmits the control signals to the switches when the driving circuit determines that the audio signal belongs to the second class signal, the switches are turned on, and the second driving signals after the switches are turned on are respectively transmitted to the voice coil sections.

8. The voice coil driving system according to claim 1, wherein the audio signal is a hybrid frequency signal, and the driving circuit comprises:
a frequency divider distinguishing the first class signal and the second class signal from the hybrid frequency signal;
a DSP electrically connected to the frequency divider and generating the first driving signal or the second driving signals according to the first class signal and the second class signal;
a plurality of amplifiers electrically connected to the DSP and the voice coil sections, wherein the amplifier corresponding to the target voice coil section amplifies and transmits the first driving signal to the target voice coil section, and the amplifiers respectively amplify and transmit the second driving signals to the voice coil sections; and
a PSU electrically connected to the amplifiers and the DSP, receiving control signals from the DSP, and activating the amplifiers according to the control signals.

9. A method of driving a voice coil, for a voice coil driving system which comprises a magnetic circuit, a voice coil suspended in the air gap and comprising a plurality of voice coil sections and a driving circuit, performed by the driving circuit and comprising:
receiving an audio signal;
determining whether the audio signal belongs to a first class signal or a second class signal;
when determining that the audio signal belongs to the first class signal, selecting a target voice coil section from the voice coil sections according to an excursion of the voice coil and generating and transmitting a first driving signal to the target voice coil section according to the first class signal; and
when determining that the audio signal belongs to the second class signal, generating and transmitting second driving signals to the voice coil sections according to the second class signal.

10. The method of driving the voice coil according to claim 9, wherein the first class signal is a low frequency signal, and the second class signal is a medium frequency signal and a high frequency signal.

11. The method of driving the voice coil according to claim 9, further comprising: according to a frequency of the first class signal, calculating the excursion of the voice coil.

12. The method of driving the voice coil according to claim 9, wherein the voice coil driving system further comprises a plurality of excursion measurement units, and the method of driving the voice coil further comprises: respectively measuring a displacement of the corresponding voice coil section by the plurality of excursion measurement units.

13. The method of driving the voice coil according to claim 9, wherein the audio signal is a hybrid frequency signal, and the method of driving the voice coil further comprises: distinguishing the first class signal and the second class signal from the hybrid frequency signal.
